(19) United States
(12) Patent Application Publication
(10) Pub. No.: US 2026/0295318 A1
(43) Pub. Date: Oct. 1, 2026

(54) VACUUM-OPERATED DRY PIPE SPRINKLER SYSTEM VALVE

(71) Applicant: Sprinkler X, LLC, Rockwall, TX (US)

(72) Inventor: Evan James Cloninger, Pasadena, CA (US)

(21) Appl. No.: 19/635,695

(22) Filed: Mar. 31, 2026

Related U.S. Application Data
(60) Provisional application No. 63/824,967, filed on Jun. 17, 2025.
(60) Provisional application No. 63/781,110, filed on Mar. 31, 2025.

(51) Int. Cl. A62C 35/68; A62C 35/62

(52) U.S. Cl. CPC A62C 35/68; A62C 35/62

(57) ABSTRACT

An apparatus includes a housing and a closure. The housing includes an inlet, an outlet, and a vent. The closure is provided at the inlet of the housing. The closure is configured to block fluid at the inlet when a vacuum state exists at the outlet. The closure is also configured to release the fluid at the inlet when the vacuum state is removed at the outlet.

### CROSS-REFERENCE TO RELATED APPLICATION AND PRIORITY CLAIM

This application claims priority under 35 U.S.C. § 119(e) to U.S. Provisional Patent Application No. 63/781,110 filed on Mar. 31, 2025, and U.S. Provisional Patent Application No. 63/824,967 filed on Jun. 17, 2025, which are hereby incorporated by reference in its entirety.

### TECHNICAL FIELD

This disclosure relates generally to fire suppression devices and processes. More specifically, this disclosure relates to a vacuum-operated dry pipe sprinkler system valve.

### BACKGROUND

Dry pipe sprinkler systems are widely used in unconditioned or unheated environments where water-filled pipes are at risk of freezing. Conventional dry systems maintain a pressurized air volume in the sprinkler piping, which holds a valve in the closed position. Upon activation of a sprinkler head due to heat or flame exposure, the pressurized air is released, allowing the valve to open and water to flow into the system.

### SUMMARY

This disclosure provides a vacuum-operated dry pipe sprinkler system valve.

In a first embodiment, an apparatus, such as a vacuum check valve, includes a housing and a closure. The housing includes an inlet, an outlet, and a vent. The closure is provided at the inlet of the housing. The closure is configured to block fluid at the inlet when a vacuum state exists inside the housing. The closure is also configured to release the fluid at the inlet when the vacuum state is removed inside the housing.

In a second embodiment, a system includes a fluid source, a piping network, and a vacuum check valve. The fluid source can maintain a supply of extinguishing fluid. The piping network is configured to guide the extinguishing fluid from the fluid source to at least one sprinkler head. The vacuum check valve is positioned in the piping network and includes a housing and a closure. The housing includes an inlet, an outlet, and a vent. The closure is provided at the inlet of the housing. The closure is configured to block fluid at the inlet when a vacuum state exists at the outlet. The closure is also configured to release the fluid at the inlet when the vacuum state is removed at the outlet.

In one or more of the above embodiments, the closure can be a flapper, and the vacuum check valve further comprises a latch configured to hold the flapper in a latched state until the vacuum state is removed at the outlet.

In one or more of the above embodiments, the vacuum check valve further can include a sealing cap extending across the vent and configured to maintain the latch in a locked state until the vacuum state is removed at the outlet. The vacuum check valve can also include a spring connected to the sealing cap configured to bias the sealing cap outward towards the vent to open the vent when the vacuum state is removed at the outlet.

In one or more of the above embodiments, the closure is a clapper.

In one or more of the above embodiments, the vacuum check valve can further include a stop configured to maintain the clapper in a closed position while the vacuum state remains at the outlet.

In one or more of the above embodiments, the vacuum check valve further can include a piston positioned in the vent and configured to block fluid flow through the vent. The vacuum check valve further a compressed spring configured to bias the piston in a manner to counter a pressure differential between ambient pressure outside of the housing and the vacuum state at the outlet.

In one or more of the above embodiments, the vacuum check valve can include a knuckle configured to maintain the clapper in a closed position while the vacuum state remains at the outlet.

In one or more of the above embodiments, the vacuum check valve can further include a secondary valve positioned at the vent and attached to the knuckle, the secondary valve is configured to move the knuckle away from the clapper when the vacuum state at the outlet is removed.

In one or more of the above embodiments, the vacuum check valve can further include a secondary door attached to the clapper and extending across an opening of the vent on an outside of the housing to seal the vent.

In one or more of the above embodiments, the secondary door is configured to maintain blocking the vent until the vacuum state is removed from the outlet, which causes the secondary door to rotate away from the vent on the outside of the housing and the clapper to rotate away from the inlet.

Other technical features may be readily apparent to one skilled in the art from the following FIGS., descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram of a example vacuum-operated dry pipe sprinkler system, showing the vacuum source, piping network, check valve, fluid source, and a sprinkler head in accordance with this disclosure;

FIG. 2 is a perspective view of an example vacuum valve for a fire sprinkler system in accordance with this disclosure;

FIG. 3 is a perspective view of a check valve for use in the sprinkler system, showing the valve body, inlet, outlet, and atmospheric vent in accordance with this disclosure;

FIG. 4 is a cross-sectional view of the check valve of FIG. 3, showing internal components including the clapper, piston, clapper arm, and stop in accordance with this disclosure;

FIG. 5A is a cross-sectional view of the valve in the closed position, showing the piston held in place by atmospheric pressure under vacuum conditions, with the clapper restrained from opening in accordance with this disclosure;

FIG. 5B is a cross-sectional view of the valve in the open position, showing the piston retracted due to loss of vacuum and the clapper allowing fluid flow in accordance with this disclosure;

FIG. 6A is a cross-sectional view of a second embodiment, showing a primary clapper held shut by a knuckle protruding from a secondary valve subjected to atmospheric pressure in accordance with this disclosure;

FIG. 6B is a cross-sectional view of the second embodiment in the open state, with the secondary valve displaced by pressure equalization and the clapper open to permit fluid flow in accordance with this disclosure;

FIG. 7A is a cross-sectional view of a third embodiment, showing a clapper rigidly linked to a secondary door, with vacuum maintaining the valve in a closed condition in accordance with this disclosure; and

FIG. 7B is a cross-sectional view of the third embodiment in the actuated position, with the pressure equalized and the clapper open to allow fluid to flow into the system in accordance with this disclosure.

### DETAILED DESCRIPTION

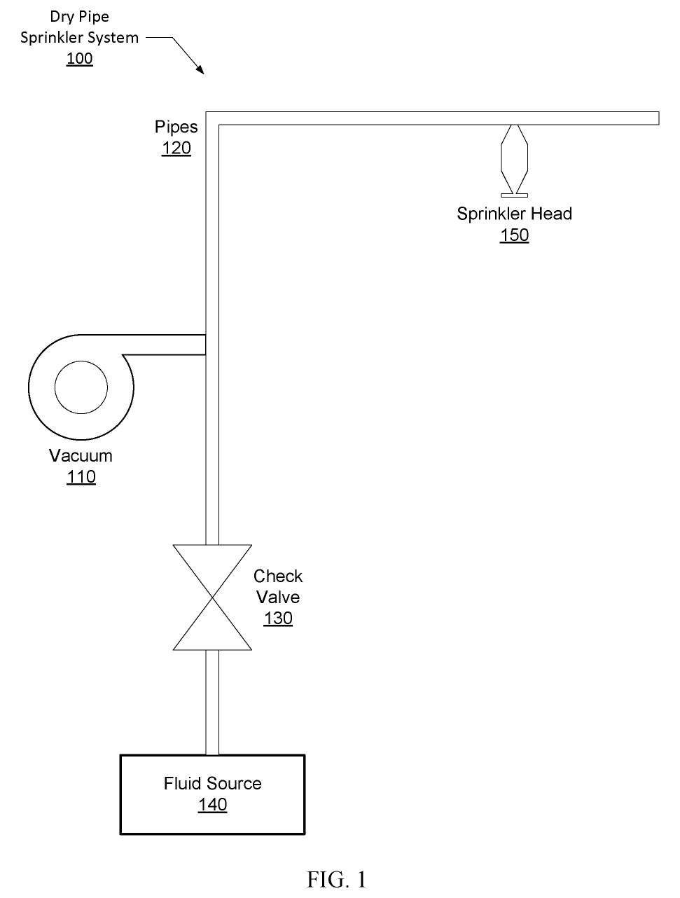

FIGS. 1 -7B, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

However, these systems are susceptible to several failure modes. Condensation within the pressurized air lines often leads to water accumulation, which in turn increases the risk of freeze-thaw damage. The presence of moisture also accelerates corrosion, reducing the functional lifespan of the piping. Resetting conventional dry valves is labor-intensive and typically requires multiple manual steps and ongoing maintenance.

While electronically monitored vacuum systems exist, such as solenoid-actuated vacuum valves that require digital controls and power, these are complex and not fully automatic. There remains a need for a mechanically actuated, vacuum-operated valve that responds reliably and automatically to sprinkler activation without electronic sensing or control.

The present disclosure provides a vacuum-operated dry pipe sprinkler valve that actuates upon the loss of internal vacuum pressure in response to a fire-triggered sprinkler head. The system maintains a vacuum (negative gauge pressure) in the dry piping, such that atmospheric air rushes into the piping when a sprinkler head opens. This change in pressure actuates the valve by a mechanical pressure differential mechanism, allowing water to flood the previously evacuated system.

The valve includes a mechanically biased clapper (flapper) assembly that is maintained in a sealed position via external atmospheric pressure acting across a vacuum-sealed chamber. When the vacuum is lost—due to sprinkler activation—the internal and external pressures equalize, causing the valve to open via spring force or mechanical advantage built into the valve geometry. In one embodiment, a piston-based actuator translates vacuum loss into motion that releases a blocking member from the clapper, allowing water to enter the system. In another embodiment, a direct linkage lever arm applies a moment force to the clapper, actuated by external atmospheric pressure when vacuum is present and released when the vacuum is lost.

The system avoids the use of electrical or digital control components, allowing fully passive, mechanical, and automatic operation. The vacuum condition also inhibits water accumulation within the piping, mitigating risks of corrosion and freeze damage.

FIG. 1 illustrates a schematic diagram of a vacuum-operated dry pipe sprinkler system 100, according to one or more embodiments. The system includes a vacuum source 110, a piping network 120, a check valve 130, a fluid source 140, and one or more sprinkler heads 150 positioned along the piping network.

The vacuum source 110 can be a device or assembly operable to reduce gas pressure within at least a portion of the piping network 120 below ambient pressure to establish and/or maintain a vacuum condition. The vacuum source 110 is operatively coupled to the piping network 120 and functions to evacuate air from within the dry pipe system, creating a negative gauge pressure (i.e., a vacuum) relative to ambient atmospheric pressure. The vacuum source 110 may include a pump, ejector, or other pressure-reducing device. The vacuum source 110 is used during normal system operation to maintain a low internal pressure in the piping network. The system 100 operates as a vacuum-operated dry pipe sprinkler system in which piping network 120 is maintained in a dry state prior to activation by establishing a vacuum condition within piping network 120 using vacuum source 110.

The piping network 120 comprises one or more interconnected pipes that are sealed to retain the vacuum condition within the system100 prior to activation and extend to the one or more sprinkler heads 150. The piping network extends from the vacuum source 110 and fluid source 140 to the various sprinkler heads 150 distributed throughout the protected area. The pipes in the piping network 120 are configured to transport a fire suppression fluid, such as water, from the fluid source 140 upon actuation of the system.

The check valve 130 can be a one-way valve positioned to permit flow in an intended direction and to inhibit reverse flow in an opposite direction. The check valve 130 is disposed between the fluid source 140 and the piping network 120. The check valve 130 is designed to remain in a closed position as long as the vacuum condition within the piping network is maintained. When the vacuum is lost, such as in response to the opening of a sprinkler head 150 triggered by fire or elevated temperature, the pressure within the piping network rises toward atmospheric pressure. The check valve 130 is mechanically configured to open in response to this loss of vacuum, thereby allowing fluid from the fluid source 140 to flow into the piping network 120. The check valve can include a closure at the inlet to prevent fluid from entering the check valve until the vacuum state on the opposite side of the closure is removed. The closure of the check valve 130 could be a flapper or a clapper.

The fluid source 140 can be a supply of extinguishing fluid in fluid communication with system 100 when permitted by check valve 130 and/or other system states. The fluid source 140 supplies the fire suppression fluid and may include a pressurized water main, a gravity-fed tank, or other fluid reservoir. The fluid source is in fluid communication with the check valve 130 such that it can supply fluid to the system once the valve actuates.

Sprinkler heads 150 can be one or more discharge devices positioned along piping network 120 and configured to release extinguishing fluid from piping network 120 to a protected area. Each sprinkler head 150 is connected to the piping network 120 and is configured to open upon detecting a fire condition, such as via a fusible element or glass bulb that breaks at a predetermined temperature. With sprinkler heads 150 installed along piping network 120, the vacuum condition may be used to support dry-pipe operation by maintaining piping network 120 substantially free of extinguishing fluid prior to activation. Upon an activation event associated with at least one of sprinkler heads 150, the vacuum condition within piping network 120 is disrupted, and the system 100 transitions to a state in which extinguishing fluid from fluid source 140 is admitted through check valve 130 into piping network 120. The extinguishing fluid then travels through piping network 120 to the activated sprinkler head(s) 150 for discharge.

In one or more embodiments, vacuum source 110 is selected and connected to piping network 120 to achieve and maintain the vacuum condition across the internal volume of piping network 120 that supplies sprinkler heads 150. The check valve 130 can be selected and installed to provide one-way flow control between the fluid source 140 and the piping network 120, thereby supporting the dry condition prior to activation and enabling rapid filling of the piping network 120 upon activation. The sprinkler heads 150 are positioned along the piping network 120 to provide coverage of a protected area, and the piping network 120 is routed to place the sprinkler heads 150 at desired locations while maintaining fluid communication back to the check valve 130 and the fluid source 140.

In the illustrated embodiment, the system 100 is configured to maintain the piping network in a normally dry and vacuum-sealed state until activation occurs through one or more sprinkler heads 150. Other embodiments may include additional components such as vacuum pressure sensors, manual override valves, or multiple check valves arranged in parallel or series depending on system configuration.

Although FIG. 1 illustrates a illustrates a schematic diagram of a vacuum-operated dry pipe sprinkler system 100, various changes may be made to FIG. 1. For example, the number and placement of various components of the dry pipe sprinkler system 100 can vary as needed or desired. In addition, the dry pipe sprinkler system 100 may be used in any other suitable fire suppression process and is not limited to the specific processes described above.

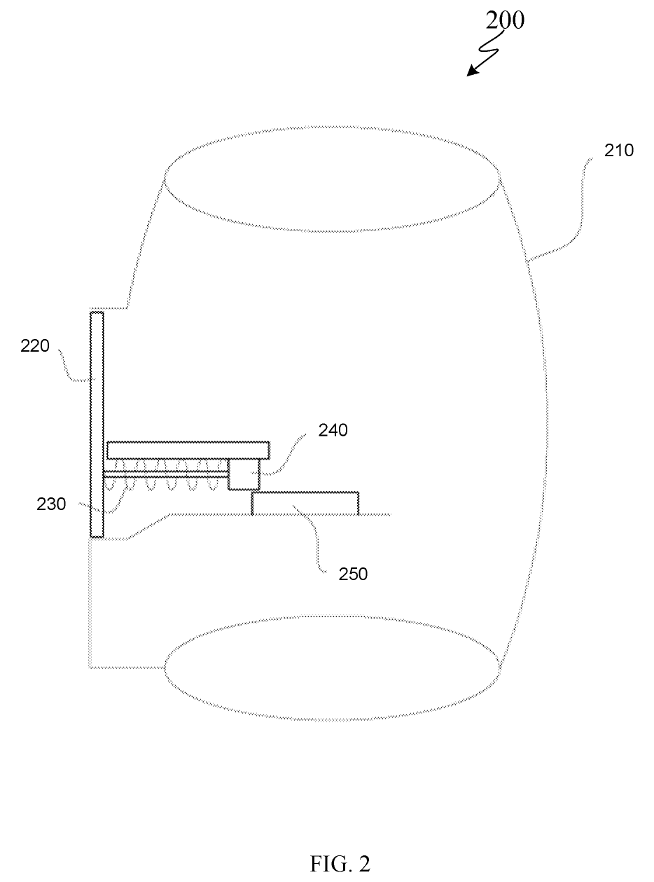

FIG. 2 is a perspective view of an example vacuum valve 200 for a fire sprinkler system 100 in accordance with this disclosure. The vacuum valve 200 can be the check valve 130 of the system 100 shown in FIG. 1.

As shown in FIG. 2, vacuum valve 200 can include a housing 210, a sealing cap 220, a spring 230, a latch 240, and a flapper 250. The housing 210 defining an inlet, an outlet, and an internal flow passage extending therebetween. In some embodiments, the housing 210 includes one or more seats, shoulders, grooves, or ledges configured to receive sealing cap 220 and to provide a sealing interface when flapper 250 is in the closed position. The housing 210 is fluidly coupled to a piping volume configured to be maintained at a sub-atmospheric pressure by a vacuum source such that, during a non-flow condition, a vacuum level within the piping volume produces a pressure differential across the closure member that urges the sealing cap 220 toward the closed position and maintains sealing engagement with the valve seat. Upon an activation condition in which the vacuum level is reduced (e. g. , by introduction of gas into the piping volume or by a pressure rise on the outlet side), the pressure differential across the sealing cap 220 decreases and/or reverses such that the net force on the sealing cap 220 permits the sealing cap 220 to unseat and move toward the open position, thereby allowing fluid to pass through the housing 210 in the forward direction while continuing to inhibit reverse flow. The sealing cap 220 may be guided by a hinge, pivot, or linear guide, and may be biased toward the closed position by a resilient member selected to provide a desired cracking threshold in combination with the effective sealing area of the valve seat and the expected vacuum range. The housing 210, valve seat, and sealing cap 220 may be formed from corrosion-resistant metals and/or polymers compatible with the intended extinguishing fluid and operating environment, and may be manufactured using casting, machining, molding, and/or assembly techniques conventional for in-line valves. For example, the housing 210 may be formed from a metal (e. g., brass, bronze, stainless steel, or cast iron) or a polymeric material suitable for the intended pressure and environmental conditions, and may be manufactured by casting, machining, molding, or combinations thereof.

In one or more embodiments, the sealing cap 220 disposed in the housing 210 is configured to transition between (i) a closed position in which the sealing cap 220 engages a valve seat to inhibit fluid flow from the outlet toward the inlet and (ii) an open position in which the sealing cap 220 is displaced from the valve seat to permit fluid flow from the inlet toward the outlet. The sealing cap 220 is a resilient sealing member positioned between housing 210 and flapper 250 to inhibit leakage when flapper 250 is in the closed position and to provide a controlled sealing area that contributes to a desired opening/closing differential. Sealing cap 220 may be implemented as an annular gasket, lip seal, O-ring, or molded profile seal seated in a corresponding groove or seat of housing 210, and may be formed from an elastomeric material such as ethylene propylene diene monomer (EPDM), nitrile rubber, silicone, fluorocarbon, or other gasket material compatible with the extinguishing fluid and expected temperature range. In assembly, sealing cap 220 is installed in the housing seat such that, upon closure, flapper 250 compresses the sealing cap 220 to form a fluid-tight seal, while allowing the flapper to unseat when the pressure differential across the flapper exceeds a predetermined threshold.

In certain embodiments, the spring 230 is attached to the sealing cap 220 to provide a bias to the sealing cap 220. The biasto the sealing cap 220 allows for the sealing cap 220 to be forced outward from the housing 210 to ensure that the vent is opened and the latch 240 is moved from the flapper 250.

In one or more embodiments, a spring 230 is a biasing element configured to urge flapper 250 toward the closed position and/or to maintain engagement between latch 240 and flapper 250 until a release condition occurs. Spring 230 may be a compression spring, torsion spring, extension spring, or other resilient member positioned between housing 210 and flapper 250 (or between housing 210 and latch 240) to apply a closing torque or closing force to the flapper 250. The spring constant and preload may be selected based on desired cracking pressure, response time, and stability against vibration or transient pressure fluctuations, and the spring may be formed from corrosion-resistant spring steel, stainless steel, or other suitable material. In one or more embodiments, spring 230 is installed in a defined pocket, post, or guide feature of housing 210 to maintain alignment during operation and to provide repeatable biasing over multiple open/close cycles.

In one or more embodiments, latch 240 is a retaining mechanism configured to selectively hold flapper 250 in a latched (e.g., closed and/or restrained) state and to release flapper 250 when a predetermined condition is met (e.g., when the vacuum is lost). Latch 240 may include a latch body, one or more ball bearings, and one or more corresponding detents, ramps, or bearing seats formed in housing 210 and/or in a latch interface component coupled to flapper 250. In operation, the ball bearings may act as rolling locking elements that engage a groove or detent to resist movement of the latch and thereby restrain flapper 250, while permitting low-friction release when an actuating force (e.g. a pressure-driven force transmitted through the flapper or a latch actuator) exceeds a threshold. In one or more embodiments, the ball bearings are retained in apertures or pockets of the latch body and are sized to protrude into mating detents such that the latch transitions between locked and unlocked states in a repeatable manner. The latch components may be manufactured from hardened steel, stainless steel, or other wear-resistant materials, and may be assembled by inserting the ball bearings into the latch body and installing the latch body into housing 210 such that the bearings align with the mating detents.

In one or more embodiments, flapper 250 is a movable closure member disposed within housing 210 and configured to open to permit fluid flow in a forward direction and to close to inhibit reverse flow. Flapper 250 may be a hinged plate, disc, or poppet-like member mounted to housing 210 via a pivot pin, hinge, or flexure, and may include a sealing surface configured to contact sealing cap 220 when in the closed position. In one or more embodiments, flapper 250 is biased by spring 230 toward the closed position and is optionally restrained by latch 240 until a release condition occurs, after which the flapper pivots or translates away from the gasket seat to allow fluid from the upstream side to pass through the valve. Flapper 250 may be formed from metal or reinforced polymer and may include features (e.g., bosses, holes, or tabs) for coupling to the hinge/pivot and for interfacing with latch 240.

Although FIG. 2 illustrates an example vacuum valve 200 for a fire sprinkler system 100, various changes may be made to FIG. 2. For example, the number and placement of various components of the vacuum valve 200 can vary as needed or desired. In addition, the vacuum valve 200 may be used in any other suitable fire suppression process and is not limited to the specific processes described above.

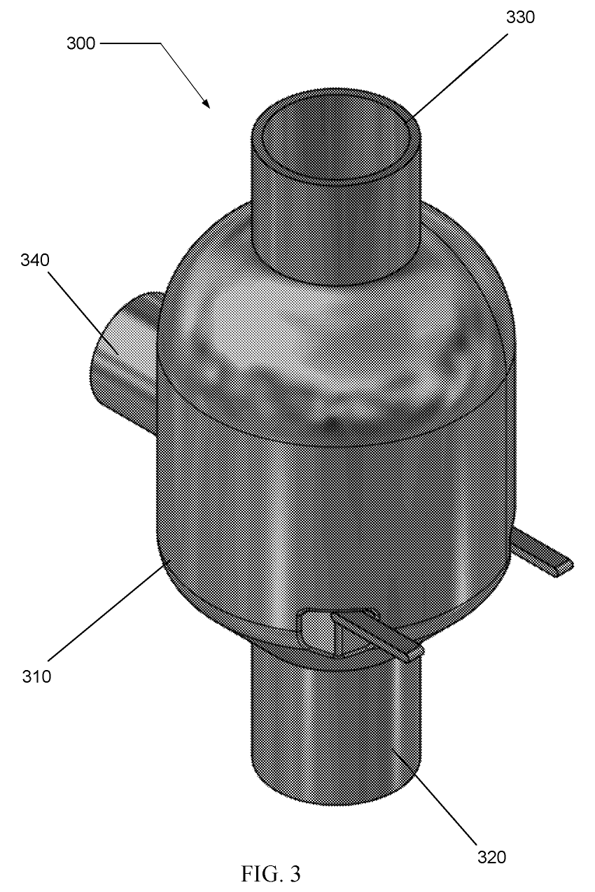

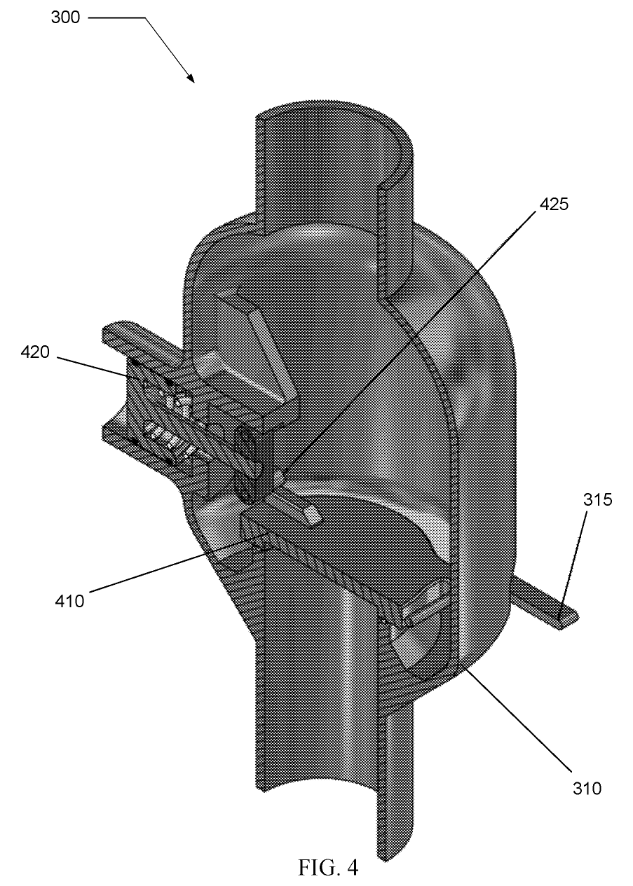

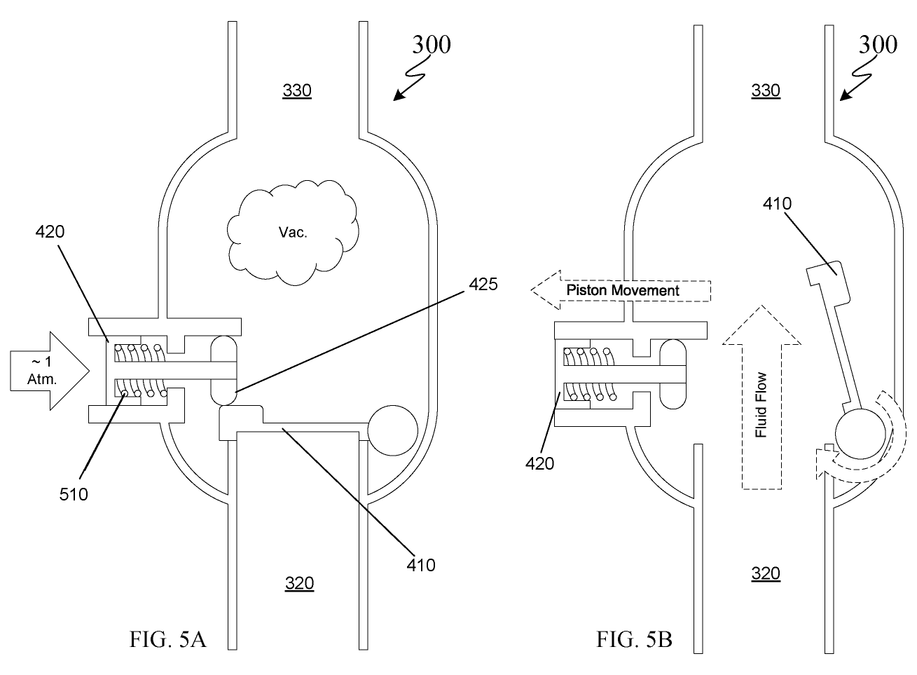

FIG. 3 is a perspective view of an example check valve 300 for use in the sprinkler system, showing the valve body, inlet, outlet, and atmospheric vent in accordance with this disclosure. FIG. 4 is a cross-sectional view of the check valve 300 of FIG. 3, showing internal components including the clapper, piston, clapper arm, and stop in accordance with this disclosure. FIG. 5A is a cross-sectional view of the check valve 300 in the closed position, showing the piston held in place by atmospheric pressure under vacuum conditions, with the clapper restrained from opening in accordance with this disclosure. FIG. 5B is a cross-sectional view of the valve in the open position, showing the piston retracted due to loss of vacuum and the clapper allowing fluid flow in accordance with this disclosure. The check valve 300 can be the check valve 130 of the system 100 shown in FIG. 1.

As shown in FIGS. 3-5B, the check valve 300 includes a valve body 310 that houses the internal flow and actuation components of the valve. The valve body 310 is configured to retain internal components in sealed engagement and provide fluid communication between an inlet 320 and an outlet 330.

The inlet 320 is located at a lower region of the valve body 310 but can be located anywhere on the valve body such that the geometry allows for proper actuation of the moving parts of the assembly, and is configured to couple with a fluid source, such as a pressurized water line or reservoir. The inlet 320 provides an entry point for fire suppression fluid into the valve when the valve transitions from a closed to an open state in response to system conditions. The internal flow path between the inlet 320 and the outlet 330 is normally blocked by a valve mechanism until a triggering event occurs, such as a loss of vacuum in the dry pipe system.

The outlet 330 is disposed at the upper region of the valve body 310 and is configured to connect to downstream sprinkler piping. When the valve is in an open state, fluid entering through the inlet 320 passes through the valve body 310 and exits through the outlet 330 toward one or more sprinkler heads.

A vent 340 is provided on a lateral surface of the valve body 310. The vent 340 is open to atmosphere and functions to allow external atmospheric pressure to act upon internal actuation components. The vent 340 may communicate with a sealed chamber within the valve such that the pressure differential between internal and external conditions governs the actuation of the valve. In particular, the vent allows the valve to maintain a closed state under vacuum conditions by using the atmospheric pressure as a closing force on a piston, diaphragm, or flapper assembly. Upon loss of vacuum in the check valve chamber or in the dry pipe system, the pressure differential is reduced or eliminated, causing the internal valve member to move to an open position.

The check valve 130 may further include mounting brackets, seals, or spring-loaded mechanisms not explicitly illustrated in the figure but necessary for mechanical operation and sealing. These components may be retained within or coupled to the valve body 310 and are selected based on the desired actuation threshold and operational pressure conditions.

The internal structure includes a valve body 310 that houses a clapper 410, a clapper arm 415, a piston 420, and a stop 425. The valve body 310 defines an internal cavity that supports fluid flow between the inlet and outlet, and houses the actuation mechanism that controls the position of the clapper 410. The clapper 410 is a movable sealing element that pivots between a closed position, in which flow through the valve is blocked, and an open position, in which fluid is permitted to pass from the fluid source to the sprinkler piping system. The clapper 410 is positioned to seal against an internal seat located above the inlet and below the outlet.

The clapper arm 415 extends from the clapper 410 and is configured to function as a mechanical interface for manually resetting the clapper 410 to the closed position following actuation. During normal operation, the clapper 410 rests against the stop 425. The stop 425 rests against a flange in the body of the valve chamber. The clapper arm 315 is rigidly attached to the clapper and passes through the body acting as an external lever without breaking the atmospheric seal of the valve chamber.

A piston 420 is mounted laterally in a chamber that is exposed on one side to the vacuum maintained in the sprinkler piping system and on the other side to ambient atmospheric pressure via a vent (not shown in this figure, see vent 340 in FIG. 4). Under vacuum conditions, the atmospheric pressure acting on the piston 420 generates a force that retains the clapper 410 in the closed position by maintaining engagement between the top of the clapper 410 and the stop 425.

Actuation of the clapper 410 is triggered by a loss of vacuum in the piping network, such as in response to the opening of a sprinkler head during a fire event. As the internal pressure equalizes with atmospheric pressure, the pressure differential across the piston 420 is eliminated. The piston 420 is thereby retracted or displaced, removing the force that holds the clapper 410 closed. With the restraining force removed, the pressure from the fluid source or an optional biasing mechanism causes the clapper 410 to rotate to the open position, allowing fluid to flow through the valve and into the sprinkler system.

The clapper arm 315 provides a means for mechanically resetting the valve to its original closed condition following actuation. This may be performed manually during system maintenance or inspection. The overall configuration provides a purely mechanical actuation mechanism driven by pressure differential, without reliance on electronic sensors or powered components.

As shown FIG. 5A, the check valve 300 is shown in a closed condition. The clapper 410 is positioned to block flow from the inlet 320 to the outlet 330. The outlet side is coupled to a vacuum-sealed sprinkler piping system. A vacuum condition is maintained in the outlet chamber, while atmospheric pressure (~1 atm) is present on the head of the piston 420. The piston 420 is retained in a forward position, urged by the pressure differential across it. The forward end of the piston is in contact with the clapper 410, directly opposing the internal water pressure acting from the inlet side. The stop 425 is positioned to physically support or locate the clapper and prevent its rotation. The net result is that the force of the inlet-side fluid is mechanically shunted through the piston 420 and into the fixed valve body via the stop.

The spring 510 is disposed beneath the head of the piston 420. In the vacuum condition illustrated, the atmospheric pressure acting over the area of the piston head dominates the spring preload, holding the piston in its forward, clapper-blocking position. A friction-reducing interface, such as a roller or bearing assembly, may be provided at the contact interface between the piston and clapper to limit wear and assist with mechanical disengagement.

FIG. 5B shows the valve in an actuated or open condition. This state is achieved when the vacuum within the outlet 330 is lost, such as through activation of a sprinkler head in the dry pipe system. As air enters and pressure equalizes, the pressure differential across the piston 420 is eliminated. With the net force of atmospheric pressure removed, the spring 510 is sufficient to retract the piston in the direction of the arrow labeled "Piston Movement." The base of the piston disengages from the clapper 410, removing the mechanical constraint.

Once released, the clapper 410 rotates about its hinge or pivot axis away from the valve seat, opening the fluid path between the inlet 320 and the outlet 330. Water or other fire suppression fluid is permitted to flow into the downstream piping network to suppress the fire condition. The resulting fluid flow path is indicated by the dashed arrows labeled "fluid flow."

In this configuration, the clapper 410 remains open while system pressure remains elevated, and the piston 420 is held in its retracted position by the compressed spring 510. Following system reset, the clapper may be mechanically repositioned to its closed position using an external interface (e.g., a clapper arm), and the vacuum may be re-established to return the piston to its forward, clapper-blocking position.

Although FIGS. 3 -5B illustrate an example check valve 300 for use in the sprinkler system, showing the valve body, inlet, outlet, and atmospheric vent, various changes may be made to FIGS. 3 -5B. For example, the number and placement of various components of the check valve 300 can vary as needed or desired. In addition, the check valve 300 may be used in any other suitable fire suppression process and is not limited to the specific processes described above.

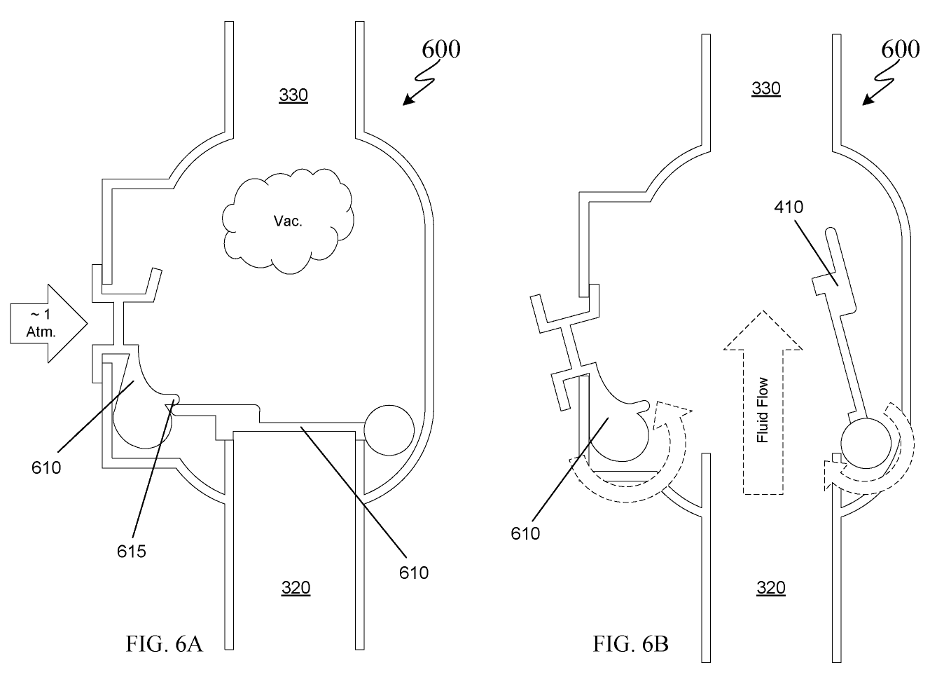

FIG. 6A is a cross-sectional view of a check valve 600, showing a primary clapper held shut by a knuckle protruding from a secondary valve subjected to atmospheric pressure in accordance with this disclosure. FIG. 6B is a cross-sectional view of the check valve 600 in the open state, with the secondary valve displaced by pressure equalization and the clapper open to permit fluid flow in accordance with this disclosure. The check valve 600 can be the check valve 130 of the system 100 shown in FIG. 1.

The valve structure includes a primary clapper 410, a secondary valve 610, and a mechanical interlock element referred to as a knuckle 615. The valve transitions from a sealed state (FIG. 6A) to an open state (FIG. 6B) in response to loss of vacuum in the sprinkler system.

In FIG. 6A, the check valve 600 is in the sealed position. The clapper 410 is positioned over the inlet 320, obstructing flow from the fluid source. A secondary valve 610 is mounted on a side wall of the valve body and is exposed to atmospheric pressure on one side and vacuum conditions on the internal side. The secondary valve 610 is a mechanically pivotable sealing member configured to close against both an inner face and an outer face of the valve body. In the closed position, the secondary valve 610 exerts a blocking force on the clapper 410 through a mechanical protrusion or stop labeled as the knuckle 615. The knuckle 615 extends radially from the secondary valve 510 and physically obstructs the movement of the clapper 410, thereby maintaining the valve in a sealed condition.

The secondary valve 610 is designed with a short moment arm relative to its pivot axis. This geometric relationship reduces the torque generated by the primary clapper’s internal fluid pressure. As a result, a relatively small pressure differential—approximately 10 to 14 psi—acting across the secondary valve 510 is sufficient to maintain the clapper 410 in the closed position, even when the fluid source applies a significantly higher pressure (e.g., 150 to 175 psi) against the clapper.

FIG. 6B shows the valve in its actuated, open state. This transition occurs when a sprinkler head connected to the outlet 330 ruptures under heat conditions, causing ambient air to enter the valve body and equalize the vacuum pressure. As the pressure differential across the secondary valve 610 is eliminated, the net force holding the secondary valve closed drops to zero. With the knuckle 615 no longer obstructing the clapper 410, the internal fluid pressure overcomes any remaining friction or sealing forces, and the clapper 410 pivots open. This allows fluid to flow from the inlet 320 through the outlet 330 into the sprinkler piping network, as indicated by the dashed flow arrows.

The secondary valve 610 may be biased toward its closed position using an eccentrically geared torsion spring. The torsion spring applies a torque to the secondary valve that increases in the clockwise direction as the valve closes, countering pressure differentials and enhancing sealing at both the inner and outer faces of the valve body. This biasing configuration improves sealing reliability and ensures that the valve returns to the desired pre-actuation position during reset procedures. Secondary valve 610 may also be assisted by a tunable counterweight that applies a tunable torque to the secondary valve 610 between open and closed states.

The geometry of the secondary valve 610 and the design of the knuckle 615 are selected to match the required actuation threshold while minimizing mechanical complexity. Together, these features enable passive, pressure-differential-based actuation of the check valve without the need for electrical or digital control systems.

Although FIGS. 6A and 6B illustrate an example check valve 600, various changes may be made to FIGS. 6A and 6B. For example, the number and placement of various components of the check valve 600 can vary as needed or desired. In addition, the check valve 600 may be used in any other suitable fire suppression process and is not limited to the specific processes described above.

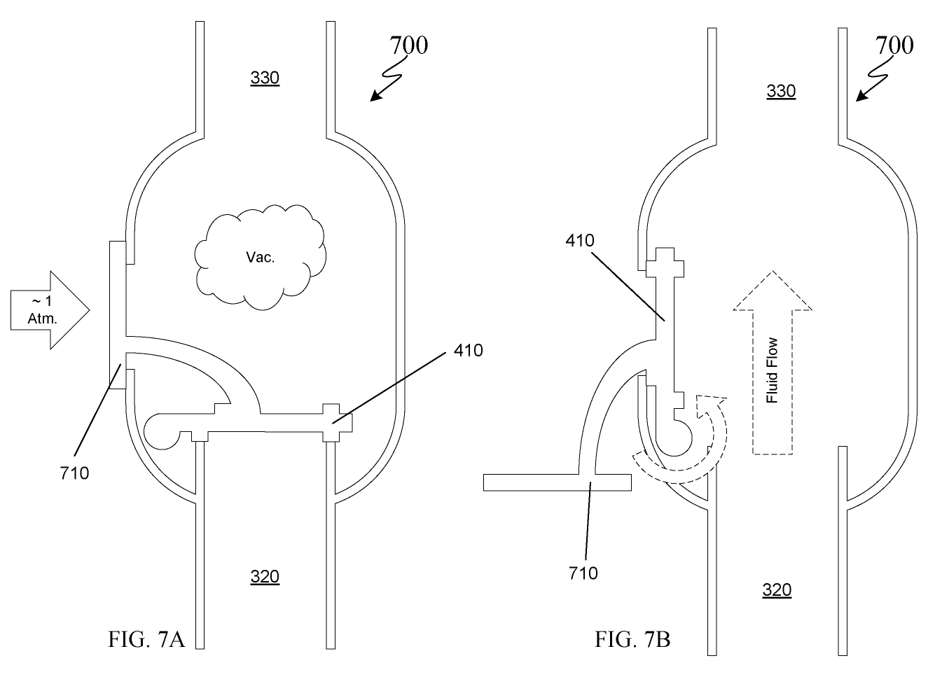

FIG. 7A is a cross-sectional view of a third embodiment, showing a clapper rigidly linked to a secondary door, with vacuum maintaining the valve in a closed condition in accordance with this disclosure. FIG. 7B is a cross-sectional view of the third embodiment in the actuated position, with the pressure equalized and the clapper open to allow fluid to flow into the system in accordance with this disclosure.

The system includes a primary clapper 410, a secondary door 710, an inlet 320, and an outlet 330. The primary clapper and secondary door are rigidly connected and pivot about a shared axis to form an integrated sealing mechanism.

In FIG. 7A, the valve is shown in a closed condition. The clapper 410 is seated against the valve body above the inlet 320, preventing fluid from flowing into the dry pipe sprinkler system. The outlet 330 is connected to a piping network under vacuum. The secondary door 710 is positioned on the opposite side of the chamber and is exposed to atmospheric pressure on its external face and to vacuum conditions on its internal face. The pressure differential across the secondary door exerts a net moment that holds the linked assembly in the closed position.

Because the clapper 410 and secondary door 710 are rigidly linked, the force applied to the secondary door from the ambient atmosphere counteracts the force applied to the clapper from fluid pressure originating at the inlet 320. The design relies on this direct force balance to maintain the valve in a sealed condition during normal operation. No independent latch or piston is used; instead, the opposing forces are mechanically transferred through the shared structure.

FIG. 7B illustrates the valve in an actuated condition. When a sprinkler head downstream opens, ambient air enters the outlet piping, eliminating the vacuum and equalizing pressure throughout the valve body. As the pressure differential across the secondary door 710 dissipates, the counteracting moment is removed. The internal fluid pressure at the inlet is no longer opposed and causes the clapper 410 to rotate open. This permits fluid to pass through the valve and into the outlet 330, as indicated by the dashed arrows representing fluid flow.

The secondary door 710 is shaped and dimensioned to seal against the valve chamber wall when the system is in vacuum conditions. The rigid coupling between the two doors ensures that the balance of pressure forces directly governs actuation. This configuration reduces mechanical complexity by eliminating intermediate linkages or latching components. The valve is reset manually by repositioning the clapper and secondary door assembly, followed by reapplication of vacuum to the sprinkler system. By modifying the area of each sealing surface, the mechanical advantage between the sealing components can be independently tuned. For example, a larger secondary door 710 will balance with a higher pressure on an otherwise unchanged clapper.

Although FIGS. 7A and 7B illustrate an example check valve 700, various changes may be made to FIGS. 7A and 7B. For example, the number and placement of various components of the check valve 700 can vary as needed or desired. In addition, the check valve 700 may be used in any other suitable fire suppression process and is not limited to the specific processes described above.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a housing including an inlet, an outlet, and a vent;
a closure provided at the inlet of the housing and configured to:
block fluid at the inlet when a vacuum state exists at the outlet; and
release fluid at the inlet when the vacuum state is removed at the outlet.

2. The apparatus of claim 1, wherein:
the closure is a flapper, and
the apparatus further comprises:
a latch configured to hold the flapper in a latched state until the vacuum state is removed at the outlet.

3. The apparatus of claim 2, further comprising:
a sealing cap extending across the vent and configured to maintain the latch in a locked state until the vacuum state is removed at the outlet, and
a spring connected to the sealing cap configured to bias the sealing cap outward towards the vent to open the vent when the vacuum state is removed at the outlet.

4. The apparatus of claim 1, wherein the closure is a clapper.

5. The apparatus of claim 4, further comprising:
a stop configured to maintain the clapper in a closed position while the vacuum state remains at the outlet.

6. The apparatus of claim 5, further comprising:
a piston positioned in the vent and configured to block fluid flow through the vent; and
a compressed spring configured to bias the piston in a manner to counter a pressure differential between ambient pressure outside of the housing and the vacuum state at the outlet.

7. The apparatus of claim 4, further comprising:
a knuckle configured to maintain the clapper in a closed position while the vacuum state remains at the outlet.

8. The apparatus of claim 7, further comprising:
a secondary valve positioned at the vent and attached to the knuckle, the secondary valve is configured to move the knuckle away from the clapper when the vacuum state at the outlet is removed.

9. The apparatus of claim 4, further comprising:
a secondary door attached to the clapper and extending across an opening of the vent on an outside of the housing to seal the vent.

10. The apparatus of claim 9, wherein the secondary door is configured to maintain blocking the vent until the vacuum state is removed from the outlet, which causes the secondary door to rotate away from the vent on the outside of the housing and the clapper to rotate away from the inlet.

11. A system comprising:
a fluid source configured to maintain a supply of extinguishing fluid;
a piping network configured to guide the extinguishing fluid from the fluid source to at least one sprinkler head;
a vacuum check valve positioned in the piping network, the vacuum check valve comprising:
a housing including an inlet, an outlet, and a vent;
a closure provided at the inlet of the housing and configured to:
block fluid at the inlet when a vacuum state exists at the outlet; and
release fluid at the inlet when the vacuum state is removed at the outlet.

12. The system of claim 11, wherein:
the closure is a flapper, and
the vacuum check valve further comprises:
a latch configured to hold the flapper in a latched state until the vacuum state is removed at the outlet.

13. The system of claim 12, wherein the vacuum check valve further comprises:
a sealing cap extending across the vent and configured to maintain the latch in a locked state until the vacuum state is removed at the outlet, and
a connected to the sealing cap configured to bias the sealing cap outward towards the vent to open the vent when the vacuum state is removed at the outlet.

14. The system of claim 11, wherein the closure is a clapper.

15. The system of claim 14, wherein the vacuum check valve further comprises:
a stop configured to maintain the clapper in a closed position while the vacuum state remains at the outlet.

16. The system of claim 15, wherein the vacuum check valve further comprises:
a piston positioned in the vent and configured to block fluid flow through the vent; and
a compressed spring configured to bias the piston in a manner to counter a pressure differential between ambient pressure outside of the housing and the vacuum state at the outlet.

17. The system of claim 14, wherein the vacuum check valve further comprises:
a knuckle configured to maintain the clapper in a closed position while the vacuum state remains at the outlet.

18. The system of claim 17, wherein the vacuum check valve further comprises:
a secondary valve positioned at the vent and attached to the knuckle, the secondary valve is configured to move the knuckle away from the clapper when the vacuum state at the outlet is removed.

19. The system of claim 14, wherein the vacuum check valve further comprises:
a secondary door attached to the clapper and extending across an opening of the vent on an outside of the housing to seal the vent.

20. The system of claim 19, wherein the secondary door is configured to maintain blocking the vent until the vacuum state is removed from the outlet, which causes the secondary door to rotate away from the vent on the outside of the housing and the clapper to rotate away from the inlet.
